(19) United States
(12) Patent Application Publication
(10) Pub. No.: US 2019/0130879 A1
(43) Pub. Date: May 2, 2019

(54) Display Driving Circuit And Operating Method Thereof

(71) Applicant: Raydium Semiconductor Corporation, Hsinchu (TW)

(72) Inventor: Hung LI, Taipei City (TW)

(21) Appl. No.: 16/175,959

(22) Filed: Oct. 31, 2018

Related U.S. Application Data
(60) Provisional application No. 62/580,511, filed on Nov. 2, 2017.

(51) Int. Cl. G09G 5/395

(52) U.S. Cl. CPC G09G 5/395

(57) ABSTRACT

A display driving circuit is disclosed. The display driving circuit includes a storing unit, a counting unit, a comparing unit and a data processing unit. The storing unit is coupled to the comparing unit and the data processing unit respectively. The counting unit is coupled to the comparing unit. The comparing unit is coupled to the data processing unit. The counting unit performs vertical/horizontal counting of display data to generate a count value. The storing unit stores a plurality of intersection location information. The comparing unit generates a compared result according to the count value and the plurality of intersection location information. The data processing unit receives the display data and the compared result respectively and correspondingly processes the display data according to the compared result and then outputs the processed display data.

### BACKGROUND OF THE INVENTION

### 1. Field of the Invention

The invention relates to a display; in particular, to a display driving circuit applied to a display and an operating method thereof.

### 2. Description of the Prior Art

In order to meet the needs of the product, the display panel needs to perform some special design, for example, the four corners of the display panel 1 is designed as the rounded corner 10 or the groove 12 is designed at the edge of the display panel 1 according to the requirement of the high screen ratio, such as FIG. 1 and FIG. 2 show. This type of design cuts off the pixels of the display panel or fills the black pixels with the display driver circuit.

If the display driver circuit is used to define the black edge curve through the formula and then add the black pixel, then each black curve needs to be analyzed. Once the number of black curves is large or complicated, the display driver circuit is difficult to apply through the formula analysis, so there are restrictions on its application.

If the memory in which the black portion picture is stored is directly placed in the display driver circuit and directly outputted to the normal picture, the more complicated black curve may be displayed, but the memory needs to be displayed. The one-to-one correspondence corresponds to each other, so that the required memory space is quite large, resulting in a substantial increase in cost.

### SUMMARY OF THE INVENTION

Therefore, the invention provides a display driving circuit applied to a display and an operating method thereof to solve the above-mentioned problems

A preferred embodiment of the invention is a display driving circuit. In this embodiment, the display driving circuit includes a storing unit, a counting unit, a comparing unit and a data processing unit. The storing unit is configured to store a plurality of intersection location information. The counting unit is configured to perform a vertical/horizontal counting of display data to generate a count value. The comparing unit is coupled to the storing unit and the counting unit and configured to generate a compared result according to the count value and the plurality of intersection location information. The data processing unit is coupled to the storing unit and the comparing unit and configured to receive the display data and the compared result respectively and correspondingly process the display data according to the compared result and then output the processed display data.

In an embodiment, the plurality of intersection position information comprises a coordinate value or a relative distance between a plurality of intersection points of a black pixel and a normal display pixel.

In an embodiment, the comparing unit compares the count value with the plurality of intersection position information to determine whether the count value meets any one of the plurality of intersection position information to generate the comparison result.

In an embodiment, the storage unit further stores a plurality of operation options and the plurality of operation options respectively correspond to the plurality of position information.

In an embodiment, when the count value meets a first intersection position information of the plurality of intersection position information, the data processing unit further receives a first operation option corresponding to the first intersection position information and processes the display data according to the first operation option and then outputs the processed display data.

In an embodiment, the storing unit is a flip-flop or a memory.

Another preferred embodiment of the invention is a display driving circuit operating method. In this embodiment, the display driving circuit operating method is used for operating a display driving circuit. The display driving circuit includes a storing unit, a counting unit, a comparing unit and a data processing unit. The storing unit is coupled to the comparing unit and the data processing unit respectively. The counting unit is coupled to the comparing unit. The comparing unit is coupled to the data processing unit. The storing unit storing a plurality of intersection location information. The display driving circuit operating method includes steps of: (a) the counting unit performing a vertical/horizontal counting of display data to generate a count value; (b) the comparing unit generating a compared result according to the count value and the plurality of intersection location information; and (c) the data processing unit receiving the display data and the compared result respectively and correspondingly processing the display data according to the compared result and then outputting the processed display data.

Compared to the prior art, the display driving circuit and the method of operating the same according to the invention can be correctly displayed and only need to be used even in a case where the number of black curves is large or complicated (for example, a rounded corner or a groove shape). A small amount of memory space can be achieved, which can effectively save memory space and cost.

The advantage and spirit of the invention may be understood by the following detailed descriptions together with the appended drawings.

### BRIEF DESCRIPTION OF THE APPENDED DRAWINGS

FIG. 1 and FIG. 2 illustrate schematic diagrams of the four corners of the display panel designed as rounded corner or the groove designed at the edge of the display panel.

FIG. 3 illustrates a schematic diagram of the display driving circuit in a preferred embodiment of the invention.

FIG. 4 illustrates a schematic diagram of obtaining a plurality of intersection points of a black pixel and a normal display pixel through a plurality of lines.

FIG. 5 illustrates an embodiment of the look-up table stored in the storing unit including a plurality of intersection position information.

FIG. 6 illustrates an embodiment of the look-up table stored in the storing unit including a plurality of intersection position information and corresponding operation options.

FIG. 7 illustrates a flowchart of the display driving circuit operating method in another preferred embodiment of the invention.

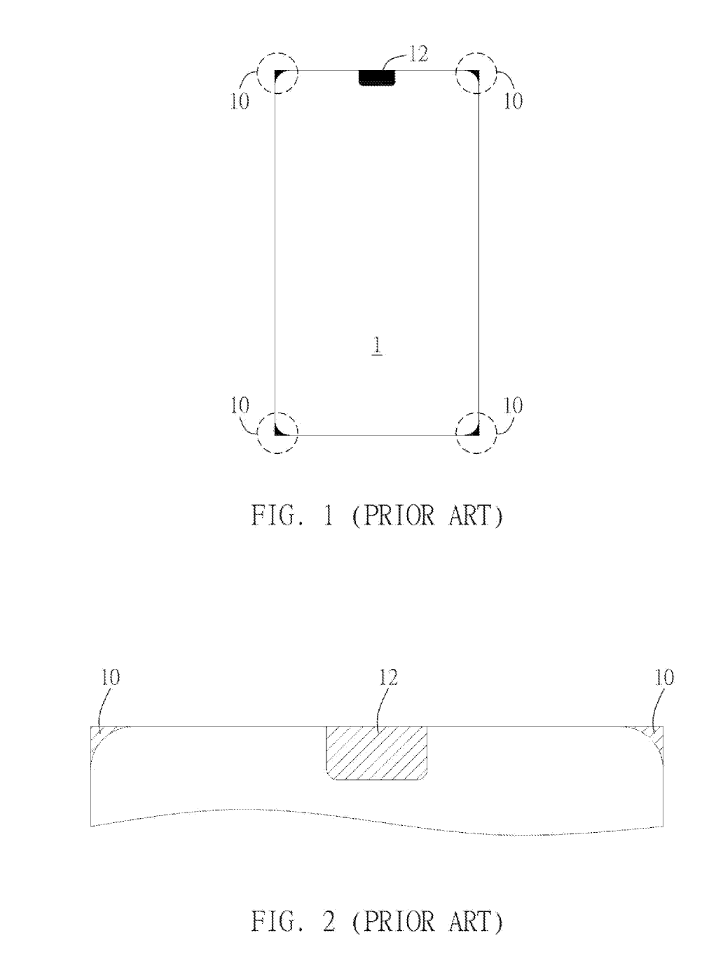

### DETAILED DESCRIPTION OF THE INVENTION

An embodiment of the invention is a display driving circuit. In this embodiment, the display driving circuit is applied to the display for driving the display panel to display images. It should be noted that the display driving circuit of the invention only needs to use a small amount of memory space to correctly display more or more complex black curves (e.g., rounded corners or groove shapes) and it can record the progressive effect or progressive interval between the black pixels and the normal display pixels. Therefore, memory space and cost can be effectively reduced.

Please refer to FIG. 3. FIG. 3 is a schematic diagram of the display driving circuit of this embodiment. The display driving circuit 2 includes a storing unit 20, a counting unit 22, a comparing unit 24 and a data processing unit 26. The storing unit 20 is coupled to the comparing unit 24 and the data processing unit 26 respectively. The counting unit 22 is coupled to the comparing unit 24. The comparing unit 24 is coupled to the data processing unit 26.

The counting unit 22 performs vertical/horizontal counting of the displayed data to generate the count value V. The storing unit 20 stores a plurality of intersection position information LC, and the intersection position information LC is related to the intersection of the black pixels and the normal displayed pixels. The comparing unit 24 generates a compared result M based on the count value V and the plurality of intersection position information LC. The data processing unit 26 receives the display data DAT and the compared result M respectively and processes the display data DAT according to the compared result M, and then outputs the processed display data DAT′.

The storing unit 20 can also store a plurality of operation options OP and the plurality of operation options OP correspond to the plurality of intersection position information LC respectively. In fact, the storing unit 20 can be a flip-flop or a memory, but is not limited thereto. Assuming that the plurality of intersection position information LC already contains row or column information, then the storing unit 20 only needs to store the coordinate information that is not included. The number of rows or columns or coordinates included in the plurality of intersection position information LC can be determined according to actual needs, and there is no specific limitation. The coordinate value can also be replaced by the relative distance, and the number of numerical bits can also be determined according to actual needs, and there is no specific limitation.

In an embodiment, the comparing unit 24 compares whether the count value V meets any one of the plurality of intersection position information LC to generate a comparison result. If the count value V meets a certain intersection position information LC, it means that the counted position is the intersection point of the black pixel and the normal display pixel.

When the count value V meets a first intersection position information of the plurality of intersection position information LC, the data processing unit 26 also receives a first operation option corresponding to the first intersection position information from the storing unit 20 and processes the display data DAT according to the first operation option, and then outputs the processed display data DAT′.

In practical applications, the plurality of intersection position information LC includes a coordinate value or a relative distance of the intersection point that a plurality of black pixels and normal display pixels intersect.

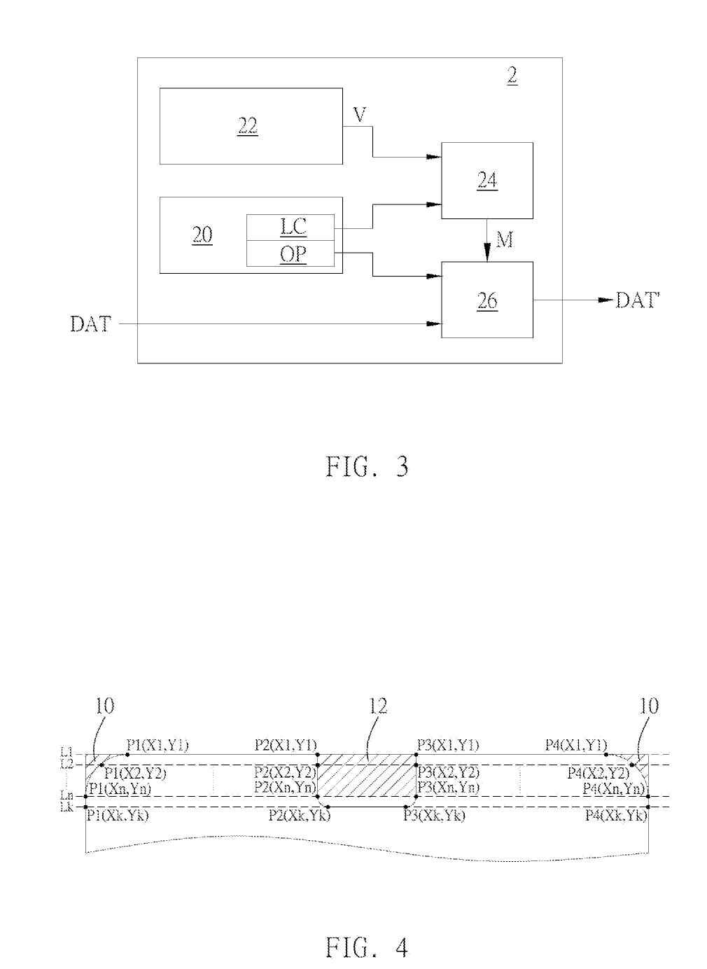

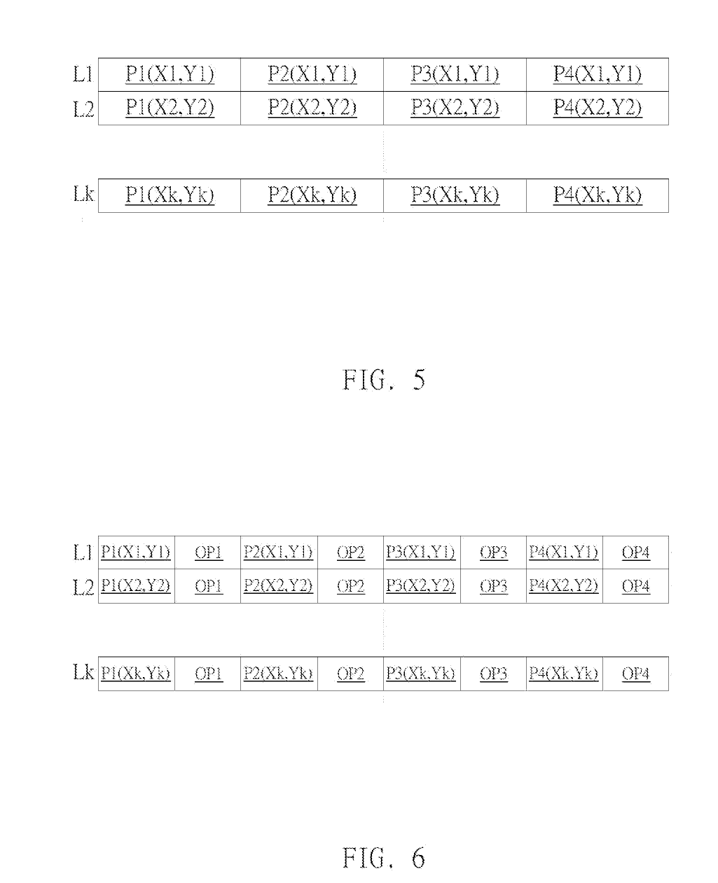

For example, as shown in FIG. 4, the first line L1˜the k-th line Lk are horizontal parallel lines. Wherein, the first line L1 passes through the intersection points P1 (X1, Y1)˜P4 (X1, Y1) that the black pixel (e.g., the rounded corner 10 or the groove 12) and the normal display pixel intersect; the second line L2 passes through the intersection points P1(X2, Y2)˜P4(X2, Y2) that the black pixel and the normal display pixel intersect; . . . ; the n-th line Ln passes through the intersection points P1(Xn, Yn)˜P4(Xn, Yn) that the black pixel and the normal display pixel intersect; the k-th line Lk passes through the intersection points P1(Xk, Yk)˜P4(Xk, Yk) that the black pixel and the normal display pixel intersect.

Taking the first line L1 as an example, if counting from the left side, the black pixel is initially displayed, and the count value does not meet any of the intersection position information LC until it counts to the intersection point P1 (X1, Y1). The count value of the intersection point P1 (X1, Y1) will correspond to a certain intersection location information LC, it means the transition from the black pixel to the normal display pixel will start from the intersection point P1 (X1, Y1). The following count values do not meet any of the intersection position information LC until it counts to the intersection point P2 (X1, Y1). The count value of the intersection point P2 (X1, Y1) will correspond to a certain intersection location information LC, it means the transition from the black pixel to the normal display pixel will start from the intersection point P2 (X1, Y1).

Similarly, the following count values do not meet any of the intersection position information LC until it counts to the intersection point P3 (X1, Y1). The count value of the intersection point P3 (X1, Y1) will correspond to a certain intersection position information LC, it means the transition from the black pixel to the normal display pixel will start from the intersection point P3 (X1, Y1). The following count values do not meet any of the intersection position information LC until it counts to the intersection point P4 (X1, Y1). The count value of the intersection point P4 (X1, Y1) will correspond to a certain intersection position information LC, it means the transition from the black pixel to the normal display pixel will start from the intersection point P4 (X1, Y1).

As for the case of the second line L2˜the fourth line L4, the same can be said, and therefore will not be described here.

Thereby, the storage unit 20 can store the lookup table and the intersection position information of the plurality of black pixels and the normal display pixels in the lookup table includes the intersection points P1 (X1, Y1)˜P4(X1, Y1), the intersection point P1(X2, Y2)˜P4(X2, Y2), the intersection point P1(Xn, Yn)˜P4(Xn, Yn) and the intersection point P1 (Xk, Yk)˜P4(Xk, Yk) corresponding to the first line L1∞the k-th line Lk respectively.

In another embodiment, as shown in FIG. 6, the storage unit 20 stores not only the intersection points P1 (X1, Y1)˜P4(X1, Y1), the intersection point P1(X2, Y2)˜P4(X2, Y2), the intersection point P1(Xn, Yn)˜P4(Xn, Yn) and the intersection point P1 (Xk, Yk)˜P4(Xk, Yk) corresponding to the first line L1˜the k-th line Lk respectively, but also the operation options OP1˜OP4 corresponding to the stored intersection points, but not limited thereto.

Another preferred embodiment of the invention is a display driving circuit operating method. In this embodiment, the display driving circuit operating method is used for operating a display driving circuit. The display driving circuit includes a storing unit, a counting unit, a comparing unit and a data processing unit. The storing unit is coupled to the comparing unit and the data processing unit respectively. The counting unit is coupled to the comparing unit. The comparing unit is coupled to the data processing unit. The storing unit storing a plurality of intersection location information.

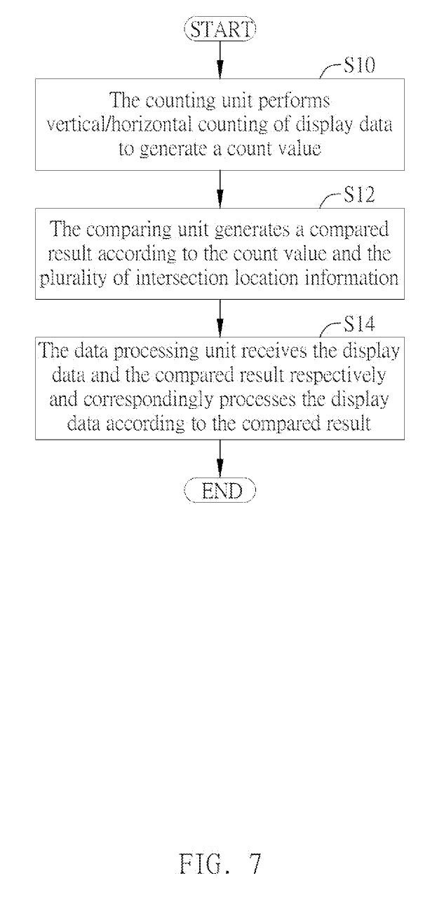

Please refer to FIG. 7. FIG. 7 illustrates a flowchart of the display driving circuit operating method in this embodiment. The display driving circuit operating method includes steps of:

Step S10: the counting unit performing a vertical/horizontal counting of display data to generate a count value;

Step S12: the comparing unit generating a compared result according to the count value and the plurality of intersection location information; and

Step S14: the data processing unit receiving the display data and the compared result respectively and correspondingly processing the display data according to the compared result and then outputting the processed display data.

Compared to the prior art, the display driving circuit and the method of operating the same according to the invention can be correctly displayed and only need to be used even in a case where the number of black curves is large or complicated (for example, a rounded corner or a groove shape). A small amount of memory space can be achieved, which can effectively save memory space and cost.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display driving circuit, comprising:
a storing unit, configured to store a plurality of intersection location information;
a counting unit, configured to perform a vertical/horizontal counting of display data to generate a count value;
a comparing unit, coupled to the storing unit and the counting unit, configured to generate a compared result according to the count value and the plurality of intersection location information; and
a data processing unit, coupled to the storing unit and the comparing unit, configured to receive the display data and the compared result respectively and correspondingly process the display data according to the compared result and then output the processed display data.

2. The display driving circuit of claim 1, wherein the plurality of intersection position information comprises a coordinate value or a relative distance between a plurality of intersection points of a black pixel and a normal display pixel.

3. The display driving circuit of claim 1, wherein the comparing unit compares the count value with the plurality of intersection position information to determine whether the count value meets any one of the plurality of intersection position information to generate the comparison result.

4. The display driving circuit of claim 1, wherein the storage unit further stores a plurality of operation options and the plurality of operation options respectively correspond to the plurality of position information.

5. The display driving circuit of claim 1, wherein when the count value meets a first intersection position information of the plurality of intersection position information, the data processing unit further receives a first operation option corresponding to the first intersection position information and processes the display data according to the first operation option and then outputs the processed display data.

6. The display driving circuit of claim 1, wherein the storing unit is a flip-flop or a memory.

7. A display driving circuit operating method, used for operating a display driving circuit, the display driving circuit comprising a storing unit, a counting unit, a comparing unit and a data processing unit, the storing unit being coupled to the comparing unit and the data processing unit respectively, the counting unit being coupled to the comparing unit, the comparing unit being coupled to the data processing unit, the storing unit storing a plurality of intersection location information, the display driving circuit operating method comprising steps of:
(a) the counting unit performing a vertical/horizontal counting of display data to generate a count value;
(b) the comparing unit generating a compared result according to the count value and the plurality of intersection location information; and
(c) the data processing unit receiving the display data and the compared result respectively and correspondingly processing the display data according to the compared result and then outputting the processed display data.

8. The display driving circuit operating method of claim 7, wherein the plurality of intersection position information comprises a coordinate value or a relative distance between a plurality of intersection points of a black pixel and a normal display pixel.

9. The display driving circuit operating method of claim 7, wherein the comparing unit compares the count value with the plurality of intersection position information to determine whether the count value meets any one of the plurality of intersection position information to generate the comparison result.

10. The display driving circuit operating method of claim 7, wherein the storage unit further stores a plurality of operation options and the plurality of operation options respectively correspond to the plurality of position information.

11. The display driving circuit operating method of claim 7, wherein when the count value meets a first intersection position information of the plurality of intersection position information, the data processing unit further receives a first operation option corresponding to the first intersection position information and processes the display data according to the first operation option and then outputs the processed display data.

12. The display driving circuit operating method of claim 7, wherein the storing unit is a flip-flop or a memory.
